(19) United States
(12) Patent Application Publication
(10) Pub. No.: US 2015/0118486 A1
(43) Pub. Date: Apr. 30, 2015

(54) EPILAME-COATED NOBLE PRODUCT

(71) Applicant: The Swatch Group Research and Development Ltd, Marin (CH)

(72) Inventors: David RICHARD, Yverdon-les-Bains (CH); Christophe LETONDOR, Le Landeron (CH)

(73) Assignee: The Swatch Group Research and Development Ltd, Marin (CH)

(21) Appl. No.: 14/521,912

(22) Filed: Oct. 23, 2014

(30) Foreign Application Priority Data
Oct. 28, 2013 (EP) 13190495.5

(51) Int. Cl. C10M 109/00; G04B 31/08

(52) U.S. Cl. CPC C10M 109/00; G04B 31/08
USPC 428/336; 428/447

(57) ABSTRACT

The present invention concerns an epilame-coated product including a substrate on which an epilame is deposited, characterized in that the product further includes an adhesion layer located between the substrate and having chemical affinity with said epilame.

This application claims priority from European Patent Application No. 13190495.5 filed on Oct. 28, 2013, the entire disclosure of which is incorporated herein by reference.

The present invention concerns a product including a fragile substrate, such as gold or rhodium, on which an epilame film is deposited.

### PRIOR ART

The proper operation of a timepiece movement depends, amongst other things, on its lubrication. The durability of the lubricant depends in particular on it being maintained in the operating area: however, all watchmakers have observed that a drop of lubricant quickly spreads over a clean part. The lubricant remains in place when its surface tension is higher than that of the substrate on which said oil is placed. If the surface tension of the oil is too low, the oil creeps and does not stay in place.

To overcome this, the substrate is coated with epilame. To achieve this, an epilame film, generally in the form of an invisible hydrophobic and oleophobic molecular layer, is deposited to prevent any creep of the lubricant and its components.

This epilame is a product which changes the apparent surface tension of the substrate. Indeed, either the epilame catches the lubricant so that it remains in place or it repels the lubricant to keep it within clearly defined areas.

There exist two categories of epilames: “mechanical” epilames which are mechanically secured to the substrate and “chemical” epilames which are generally formed of 2 parts: the anchor (which will promote chemical adherence to the substrate) and the functional body (which provides the epilame power to the molecule, via fluorinated elements for example).

One current drawback lies in the fact that mechanical epilames have limited natural resistance to cleaning operations (poor chemical adherence to surfaces as not necessarily optimised therefor, and even less adherence to gold and rhodium due to their chemical surface nature). Agitation, cleaning baths, the temperature of solutions, etc. thus contribute to degradation of mechanical epilames. In FIG. 1, a product 1 including a substrate 2 unsuitable for an epilame 3 is shown. This substrate 2 is required carry a lubricant 5.

In area A, an epilame 3 is placed on the substrate, allowing the lubricant to be held on said substrate 2. Area B shows the same substrate 2 having undergone horological cleaning operations. It is noted that epilame 3 is no longer present.

Currently, the chemical epilames used are epilames having for example a silane anchor. When this epilame is deposited on a steel substrate, the surface oxides which are naturally present provide covalent or strong adherence between the silane anchor and the surface oxide.

For chemical epilames, a drawback arises when the substrate is fragile. A fragile substrate is a substrate that may be made of gold, rhodium or plastic. In that case, the usual epilame anchors (silane anchors) which like to attach to surface oxides are unable to chemically attach to gold or rhodium plated surfaces because of low chemical affinity. Consequently, only mechanical anchorage, similar to that of a layer of paint on a substrate, is achieved and this type of substrate does not offer sufficient resistance to horological cleaning operations.

### SUMMARY OF THE INVENTION

The invention concerns an epilame-coated product which overcomes the drawbacks of the prior art, namely which makes it possible to provide a product whose epilame or molecular Epilame coating is resistant to horological cleaning operations regardless of the nature of the substrate.

To this end, the invention concerns an epilame-coated substrate including a substrate on which epilame is deposited, characterized in that the product further includes an adhesion layer located between the substrate and the epilame and having chemical affinity with said epilame so that said epilame and said substrate can be hooked together via a chemical linkage.

In a first embodiment, the epilame includes an anchor part and a functional part, said adhesion layer having chemical affinity with said anchor part.

In a second embodiment, the anchor is of the silane type and the adhesion layer is an oxide.

In a third embodiment, the oxide of the adhesion layer is chosen from the list including silicon oxide, aluminium oxide, titanium dioxide or a combination of these elements.

In a fourth embodiment, the substrate has low chemical affinity with the epilame.

In another embodiment, the substrate is a polymer.

In another embodiment, the substrate has a rhodium or gold plated substrate.

In another embodiment, the adhesion layer is invisible and reveals that the substrate is below such that the aesthetic appearance of the substrate is not impaired.

In another embodiment, the adhesion layer has a thickness of 1 to 500 nm.

In another embodiment, the chemical linkage is of the covalent type.

In another embodiment, the chemical linkage is the hydrogen linkage.

The present invention also concerns a timepiece including the epilame-coated product of the invention.

### BRIEF DESCRIPTION OF THE DRAWINGS

The objects, advantages and features of the present invention will appear more clearly in the following detailed description of at least one embodiment of the invention, given solely by way of non-limiting example and illustrated by the annexed drawings, in which:

FIG. 1 is a schematic view of the epilame-coated product according to the prior art.

FIG. 2 is a schematic view of the epilame-coated product according to the present invention.

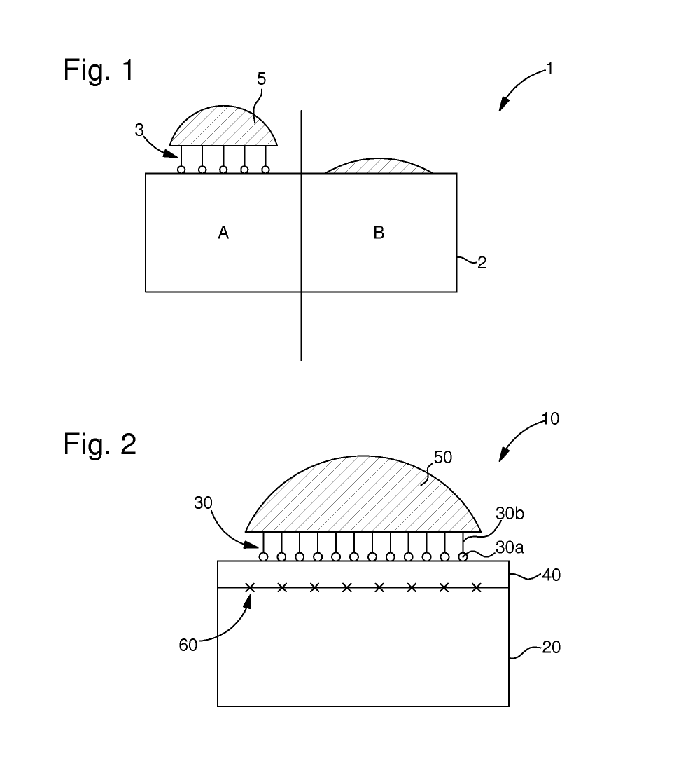

### DETAILED DESCRIPTION

FIG. 2 shows the epilame-coated product 10 according to the present invention. This product includes a substrate 20. This substrate 20 is the product on which epilame 30 or the Epilame molecular layer will be placed. This product 10 may be a part of a timepiece movement such as a bridge or the main plate. This product 10 may also be a part of a micromechanical object such as a music box. Of course, this product may be suited to all applications using an epilame. The horological application will be used in the following description.

Substrate 20 is made of a first material which may be a known watchmaking material such as steel or brass.

A chemical epilame layer 30 must be deposited on the substrate. A chemical epilame 30 is generally formed of two parts: a part called the anchor 30a which will promote chemical adherence to substrate 20 and a part called the functional body 30b which gives the epilame power to the molecule, via fluorinated elements for example.

In order to ensure good adherence of epilame 30 to substrate 20 regardless of the nature of the substrate, the present invention consists in providing an adhesion layer 40 located between substrate 20 and epilame 30, as seen in FIG. 2.

Advantageously, this adhesion layer 40 possesses the peculiarity of good affinity with any type of substrate, and good affinity with the epilame 30 so that the connection between adhesion layer 40 and epilame 30 is strong. This affinity of the layer 40 with substrate 20 and epilame 30 provides good adhesion of epilame 30 to substrate 20 regardless of the nature of substrate 20. The crosses 60 visible in FIG. 2 show that the affinity between substrate 20 and layer 40 provide strong adherence.

The adhesion layer is selected in accordance with the epilame chosen. Indeed, the part called anchor 30a which will promote chemical adherence to substrate 20 is not universal, so there is no anchor which reacts with all substrates 20. It is therefore necessary to adapt anchor 30a and adhesion layer 40 to achieve good affinity.

For example, an ordinary anchor is a silane anchor 30a having the following structure:

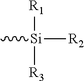

R1 refers to an C1-C18 alkoxy group or a C5-C18 cycloalkoxyl group, and preferably a group selected from C1-C4 alkoxyl especially methoxyl and ethoxyl or a hydroxyl group or a halogen group and preferably chlorine group.

R2 and R3 are the same or different and refers to a C1-C18 alkoxy group or a C5-C18 cycloalkoxy group and preferably a group selected from C1-C4 alkoxyl especially methoxyl and ethoxyl group or a hydroxyl group or a halogen group and preferably chlorine or a hydrogen atom or a C1-C10 linear or branched alkyl radical, C5-C18 cycloalkyl, C6-C18 aryl, preferably C1-C4 alkyl, preferably a methyl or ethyl radical.

These silane anchors 30a have good affinity with surface oxides. Adhesion layer 40 may then be formed of an oxide, such as silicon oxide SiO2, alumina or aluminium oxide Al2O3, titanium dioxide TiO2 or a combination of these three elements. For this type of adhesion layer 40, anchors 30a of the phosphoric or catechol derivative type may also be used. This results in a covalent linkage of the type in which two atoms sharing two electrons (one electron or two electrons from each of the same atom) of theft outer layers to form a pair of electrons between the two atoms.

Of course, other types of linkage are possible and linkages of an hydrogen type used to link a compound donor with acid H, that is to say a hydrogen atom linked to a heteroatom (such as amines, alcohols, thiols) and an acceptor comprising a heteroatom (only nitrogen, oxygen or fluorine) carrying a one pair.

It therefore becomes possible to create epilame-coated products with a fragile substrate 20, like those created with plastic materials such as polymers or gold or rhodium plated materials, which naturally exhibit poor adhesion to epilame 30 having a silane anchor. These substrates do not, in fact, have surface oxide for grip a epilame 30 having a silane anchor. Substrate 20 may also be a steel metal type substrate having a gold or rhodium plated surface.

To create such an epilame-coated product 10, a first step consists in taking substrate 20, i.e. the part which is to be coated with epilame 30.

Once substrate 20 is obtained, a deposition step is performed. This deposition step consists in depositing adhesion layer 40 on substrate 20. Several methods may be used to achieve this.

A first method consists in using an evaporation under vacuum technique. This evaporation under vacuum technique relies on two elementary processes: evaporation from a heated source and condensation to the solid state of the evaporated material on the substrate. Evaporation occurs under vacuum, i.e. in a gaseous environment, apart from the deposition vapour, containing extremely few particles. In these conditions, the particles of material can propagate to the target without colliding with other particles (for example in a vacuum of 10⁻⁴ Pa, a particle that is 0.4 nm in diameter has a mean free travel of 60 m, i.e. it can travel an average of sixty metres before colliding with another particle). Indeed, the collision of different atoms during evaporation may cause reactions liable to modify the nature of the required deposition. For example, in the presence of oxygen, aluminium will form aluminium oxide. This phenomenon may also decrease the quantity of deposited vapour.

Another method consists in using a flash evaporation method. In a flash evaporation method, the material to be deposited is in the form of a wire which is continually unwound and evaporated by contact with a very hot ceramic bar.

Another method used is atomic layer deposition (ALD). This method is a method of depositing thin atomic layers. The principle consists in exposing a surface to a series of different chemical parent substances in order to obtain ultra-thin layers.

The deposited adhesion layer thus adheres to the substrate. The deposited layer has a thickness of around 1 to 500 nanometres.

The last step then consists in depositing a drop of epilame 3 on the required area.

According to a first variant of the invention, adhesion layer 40 is arranged to be invisible or transparent that is to say, it leaves appear the substrate. This feature makes it possible to obtain an adhesion layer 40 without deteriorating the appearance of the substrate. Indeed, the advantage of a gold or rhodium plated substrate 20 is having a superior visual effect. This effect must not, therefore, be deteriorated by a layer which will conceal substrate 20.

It will be clear that various alterations and/or improvements and/or combinations evident to those skilled in the art may be made to the various embodiments of the invention set out above without departing from the scope of the invention defined by the annexed claims.

What is claimed is:

1. An epilame-coated product including a substrate on which an epilame is deposited, wherein the product further includes an adhesion layer located between the substrate and the epilame and having chemical affinity with said epilame so that said epilame and said substrate can be hooked together via a chemical linkage.

2. The product according to claim 1, wherein the epilame includes at least an anchor part and a functional part, said adhesion layer having chemical affinity with said anchor part.

3. The product according to claim 1, wherein the chemical linkage is of the covalent type.

4. The product according to claim 2, wherein the chemical linkage is of the covalent type.

5. The product according to claim 1, wherein the chemical linkage is the hydrogen linkage.

6. The product according to claim 2, wherein the chemical linkage is the hydrogen linkage.

7. The product according to claim 2, wherein the anchor is of the silane type and the adhesion layer is an oxide.

8. The product according to claim 3, wherein the anchor is of the silane type and the adhesion layer is an oxide.

9. The product according to claim 4, wherein the anchor is of the silane type and the adhesion layer is an oxide.

10. The product according to claim 7, wherein the oxide of the adhesion layer is selected from the list including silicon oxide, aluminium oxide, titanium dioxide or a combination of these elements.

11. The product according to claim 8, wherein the oxide of the adhesion layer is selected from the list including silicon oxide, aluminium oxide, titanium dioxide or a combination of these elements.

12. The product according to claim 9, wherein the oxide of the adhesion layer is selected from the list including silicon oxide, aluminium oxide, titanium dioxide or a combination of these elements.

13. The product according to claim 1, wherein the substrate has low chemical affinity with the epilame.

14. The product according to claim 13, wherein the substrate is a polymer.

15. The product according to claim 13, wherein the substrate has a rhodium or gold plated surface.

16. The product according to claim 1, wherein the adhesion layer is invisible and reveals that the substrate is below such that the aesthetic appearance of the substrate is not impaired.

17. The product according to claim 1, wherein the adhesion layer has a thickness of 1 to 500 nm.

18. A timepiece including an epilame-coated product according to claim 1.
